(19) United States
(12) Patent Application Publication
(10) Pub. No.: US 2013/0152118 A1
(43) Pub. Date: Jun. 13, 2013

(54) APPARATUS AND METHOD FOR ACQUIRING CHANNEL INFORMATION USING BROADCAST DATA

(71) Applicants: Seung Hun Oh, Daejeon (KR); Byung Tak Lee, Daejeon (KR); Seok Kap Ko, Daejeon (KR); Nac Woo Kim, Daejeon (KR); Jai Sang Koh, Daejeon (KR)

(72) Inventors: Seung Hun Oh, Daejeon (KR); Byung Tak Lee, Daejeon (KR); Seok Kap Ko, Daejeon (KR); Nac Woo Kim, Daejeon (KR); Jai Sang Koh, Daejeon (KR)

(73) Assignee: Electronics and Telecommunications Research Institute, Daejeon (KR)

(21) Appl. No.: 13/817,675

(22) PCT Filed: Aug. 19, 2011
(86) PCT No.: PCT/KR11/06126

§ 371 Date: Feb. 19, 2013

(30) Foreign Application Priority Data
Aug. 19, 2010 (KR) 10-2010-0080404
Jun. 30, 2011 (KR) 10-2011-0064661

(51) Int. Cl. H04N 21/44

(52) U.S. Cl. CPC H04N 21/44008
USPC 725/19

(57) ABSTRACT

The present invention relates to an apparatus and method for obtaining a viewing channel identifier when a user desires to participate in a video broadcast in a channel the user is viewing in a section of an interactive broadcast service. The present invention may include an audio/video receiver to collect broadcast data from a user viewing channel, and extract audio/video data from the collected broadcast data, a sampling unit to sample the extracted audio/video data, a preprocessing unit to encode the sampled audio/video data, and a viewing channel determining unit to compare the encoded audio/video data to audio/video sampling data for N broadcast channels received from a channel identification server, and obtain a viewing channel identifier according to a result of comparison.

### TECHNICAL FIELD

The present invention relates to an apparatus and method for obtaining a viewing channel identifier when a user desires to participate in a video broadcast on a channel being viewed by the user, in a section of an interactive broadcast service.

### BACKGROUND ART

An interactive broadcast service refers to a bidirectional broadcast service in which a viewer may participate in a video broadcast using relatively simple user equipment. The interactive broadcast service may be in a form of a supplementary service available for various broadcasting networks (systems) such as a ground wave, a satellite, a cable, an Internet protocol television (IPTV), and the like. In order to support the interactive broadcast service, research is conducted on a system that may be easily applied using a form independent of a conventional system, or operating in minimal conjunction with a conventional system. A conjunction with a broadcast channel identifier may be used for a conjunction between a conventional broadcast and an interactive broadcast system.

A basic broadcast system may use a “viewing channel identifier” corresponding to a unique identifier that may identify each broadcast channel. The interactive broadcast service may assign and manage a “participation channel identifier” associated with the viewing channel identifier. The participation channel identifier may correspond to an identifier that is used for technically identifying a channel in which a broadcast terminal desires to participate.

The participation channel identifier may be mapped to the viewing channel identifier, and be managed. To use the interactive broadcast service, a user terminal may obtain the participation channel identifier so that, a user may participate in a broadcast the user is currently viewing.

Viewing information of a user has been collected to survey viewer ratings. In general, the viewing information may be directly obtained by a scheme that uses software for obtaining channel changing information in a viewing device. Various schemes may be used to obtain viewing information.

However, in a conventional scheme described in the foregoing, a conjunction between a system and a conventional broadcast system may be used, and a separate collection and correction of viewing information may be used on the corresponding broadcast system.

### DISCLOSURE OF INVENTION

### Technical Goals

An aspect of the present invention provides an apparatus and method for obtaining broadcast channel information (or a viewing channel identifier) by applying a technology for detecting, based on a broadcast audio and video, a viewing channel identifier so as to minimize a separate conjunction with a conventional broadcast system.

Another aspect of the present invention provides an apparatus and method for using an interactive broadcast service by obtaining, using the obtained viewing channel identifier, a participation channel identifier that is used for participating in a broadcast.

### Technical Solutions

According to an aspect of the present invention, there is provided an apparatus for obtaining channel information using broadcast data, the apparatus including an audio/video receiver to collect broadcast data from a user viewing channel, and extract audio/video data from the collected broadcast data, a sampling unit to sample the extracted audio/video data, a preprocessing unit to encode the sampled audio/video data, and a viewing channel determining unit to compare the encoded audio/video data to audio/video sampling data for N broadcast channels received from a channel identification server, and obtain a viewing channel identifier according to a result of comparison.

The sampling unit may perform sampling by extracting continuous audio/video data for a predetermined time period.

The audio/video receiver may include a microphone module for collecting audio data and a camera module for collecting video data, the audio data and the video data being received by a broadcast receiver.

The viewing channel determining unit may determine the viewing channel identifier by extracting sampling data of a broadcast channel including a section that corresponds to sampling data of the viewing channel included in the audio/video sampling data for N broadcast channels received from the channel identification server.

The viewing channel identifier may correspond to an identifier capable of identifying at least one among a channel number, a channel identification (ID), a channel uniform resource locator (URL), a multicast number, and a port number.

The apparatus may further include a participation signal transmitter to request, using the viewing channel identifier in the viewing channel determining unit, the channel identification server to search for a participation channel identifier, and to transmit a broadcast participation request signal to a participation control server using the requested participation channel identifier.

According to another aspect of the present invention, there is provided an apparatus for obtaining channel information using broadcast data, the apparatus including a broadcast data receiver to receive, from a broadcasting station, broadcast data for N channels, and to extract audio or video data from the received broadcast data, a sampling unit to sample the audio or video data extracted by the broadcast data receiver, a preprocessing unit to encode the sampled audio or video data, a sampling data storage unit to store the encoded audio or video data, and a viewing channel determining unit to compare sampling data stored in the sampling data storage unit to audio or video sampling data for a user viewing channel received from a broadcast participation device, and to obtain a viewing channel identifier of the user viewing channel according to a result of comparison.

The sampling unit may perform sampling by extracting continuous audio or video data, for a predetermined time period, for each of N channels received from the broadcasting station.

The sampling data storage unit may store time information of the audio or video sampling data.

The viewing channel identifier may correspond to an identifier capable of identifying at least one among a channel number, a channel ID, a URL, a multicast number, and a port number.

The apparatus may further include a transmitter to search for a participation channel identifier with reference to the viewing channel identifier in the viewing channel determining unit, and to transmit, to the broadcast participation device, the viewing channel identifier including the participation channel identifier searched for.

According to still another aspect of the present invention, there is provided a method of obtaining channel information using broadcast data, the method including receiving broadcast data of a viewing channel, extracting audio or video data from the received broadcast data, sampling the extracted audio or video data, comparing the sampled audio or video data to audio or video sampling data for N broadcast channels received from a channel identification server, and obtaining a viewing channel identifier of the viewing channel according to a result of comparison.

The sampling may include extracting data during a sampling window of a predetermined section for audio or video data of a viewing channel, and generating a quantized sample bit stream for the extracted data.

The method may further include searching for a participation channel identifier with reference to the obtained viewing channel identifier, and requesting an interactive broadcast by transmitting the participation channel identifier searched for to a participation control server.

According to yet another aspect of the present invention, there is provided a method of obtaining channel information using broadcast data, the method including receiving, from a broadcasting station, broadcast data for each broadcast channel, extracting audio or video data from the received broadcast data, sampling the extracted audio or video data, comparing the sampled audio or video data to audio or video sampling data for a user viewing channel received from a broadcast participation device, and obtaining a viewing channel identifier for the viewing channel according to a result of comparison.

The sampling may include setting a sampling section for a continuous audio or video signal for a predetermined time period, and generating a quantized sample bit stream for audio or video data of the sampling section.

The method may further include searching for a participation channel identifier with reference to the obtained viewing channel identifier, and transmitting, to the broadcast participation device, the participation channel identifier searched for and the viewing channel identifier.

According to further another aspect of the present invention, there is provided an apparatus for obtaining channel information using broadcast data, the apparatus including an audio/video receiver to collect broadcast data from a user viewing channel, and to extract audio or video data from the collected broadcast data, a sampling unit to sample the extracted audio or video data, a preprocessing unit to encode the sampled audio or video data, and a transmitter to transmit, to a channel identification server, the encoded audio or video data.

The viewing channel identifier and a broadcast participation identifier may be received from the channel identification server, and the received viewing channel and broadcast participation identifiers may be transmitted to a broadcast participation server to request an interactive broadcast.

The sampling unit may perform sampling by extracting continuous audio or video data for a predetermined time period.

### Effect of the Invention

According to an aspect of the present invention, it is possible to easily obtain information about a participating broadcast channel in an interactive broadcast system.

According to another aspect of the present invention, it is possible to obtain a viewing channel identifier in a device separated from a viewing device.

### BRIEF DESCRIPTION OF DRAWINGS

FIG. 1 is a diagram illustrating a configuration of an interactive broadcast system for obtaining a viewing channel identifier according to an embodiment of the present invention.

FIG. 2 is a block diagram illustrating a configuration of a system connection for obtaining a viewing channel identifier according to an embodiment of the present invention.

FIG. 3 is a block diagram illustrating a configuration of a system connection for obtaining a viewing channel identifier according to another embodiment of the present invention.

FIG. 4 is a block diagram illustrating a configuration of a system connection for obtaining a viewing channel identifier according to still another embodiment of the present invention.

FIG. 5 is a diagram illustrating a sampling operation for obtaining a viewing channel identifier in a broadcast participation device according to an embodiment of the present invention.

FIG. 6 is a diagram illustrating a sampling operation for obtaining a viewing channel identifier in a channel identification server according to an embodiment of the present invention.

FIG. 7 is a flowchart illustrating an operation of collecting sampling data of a broadcast channel in a channel identification server according to an embodiment of the present invention.

FIG. 8 is a flowchart illustrating an operation of a system for obtaining a viewing channel identifier according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

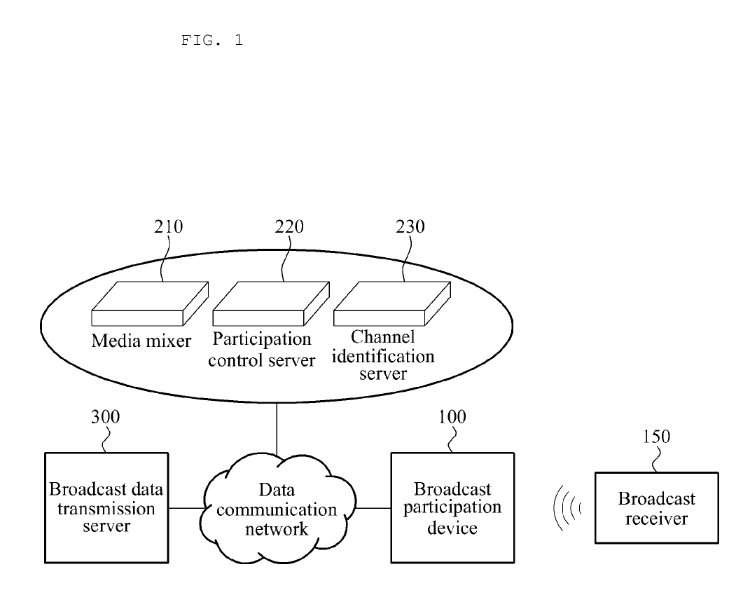

FIG. 1 is a diagram illustrating a configuration of an interactive broadcast system for obtaining a viewing channel identifier according to an embodiment of the present invention.

Referring to FIG. 1, a system for obtaining an interactive broadcast service may include a broadcast receiver 150, a broadcast participation device 100, a media mixer 210, a participation control server 220, a channel identification server 230, and a broadcast data transmission server 300.

The broadcast receiver 150 may output broadcast data that is received from a broadcasting station. The broadcast receiver 150 according to embodiments of the present invention may receive, from the broadcast data transmission server 300 of the broadcasting station, broadcast data including audio and video data, and various information data. The broadcast receiver 150 may classify the received broadcast data, and may provide a user with audio, video, and various types of information.

The broadcast participation device 100 may collect broadcast data of a viewing channel, and may extract audio or video data from the collected broadcast data. The broadcast participation device 100 may sample the extracted audio or video data. The broadcast participation device 100 may transmit the sampled audio or video data to the channel identification server 230. Alternatively, the broadcast participation device 100 may compare the sampled audio or video data to sampling data for a broadcast channel received from the channel identification server 230, and may obtain a viewing channel identifier.

The participation control server 220 may control user participation, and control a participation broadcast service.

The media mixer 210 may compose a broadcast original media and a media input from viewers, and generate a final broadcast media. Through the interactive broadcast service, data input from a viewer and a broadcast original media may be composed and delivered to a broadcast system to be output to the broadcast receiver 150.

The channel identification server 230 may perform a function for identifying a channel a viewer is viewing based on information extracted by sampling a broadcast audio and video in the broadcast participation device 100. The channel identification server 230 may manage a participation channel identifier generated in the participation control server 220. The channel identification server 230 may determine, using audio or video image sample data input from the broadcast participation device 100, a viewing channel identifier for a channel a viewer is viewing, and may search for a participation channel identifier that matches the viewing channel identifier.

The broadcast data transmission server 300 may correspond to a cable broadcast server, a skywave broadcast server, an Internet protocol (IP) broadcast server according to a broadcast service type. The broadcast data transmission server 300 may transmit, to the broadcast receiver 150, broadcast data including audio, video, and information data for a broadcast selected by a viewer. The broadcast data transmission server 300 may transmit, to the channel identification server 230, audio or video data for all broadcast channels.

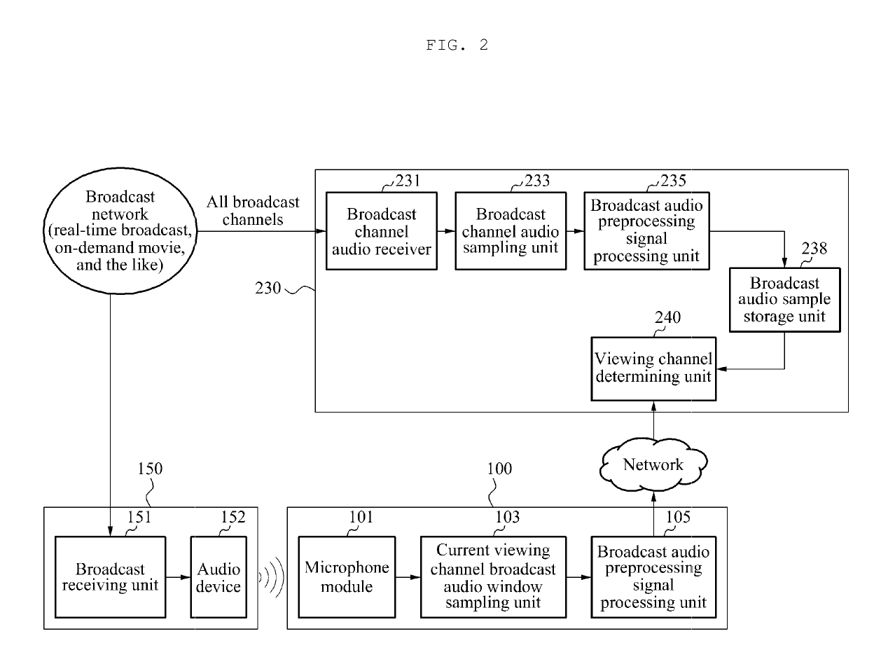

FIG. 2 is a block diagram illustrating a configuration of a system connection for obtaining a viewing channel identifier according to an embodiment of the present invention.

FIG. 2 illustrates a configuration for obtaining a viewing channel identifier in a channel identification server using audio data of a viewing channel and audio data of all broadcast channels.

According to an embodiment of the present invention, a system for obtaining a viewing channel identifier using audio data in broadcast data will be described with reference to FIG. 2.

The system for obtaining a viewing channel identifier according to an embodiment of the present invention may include a channel identification server 230, a broadcast receiver 150, and a broadcast participation device 100.

The channel identification server 230 may include a broadcast channel audio receiver 231, a broadcast channel audio sampling unit 233, a broadcast audio preprocessing signal processing unit 235, a broadcast audio sample storage unit 238, and a viewing channel determining unit 240.

The broadcast channel audio receiver 231 may receive audio data for all broadcast channels received through a broadcast network, and may deliver the audio data to the broadcast channel audio sampling unit 233.

The broadcast channel audio sampling unit 233 may sample the audio data for all broadcast channels received through the broadcast channel audio receiver 231. The broadcast channel audio sampling unit 233 may convert, using a sampling algorithm, a continuous audio signal for the audio data into a digital signal.

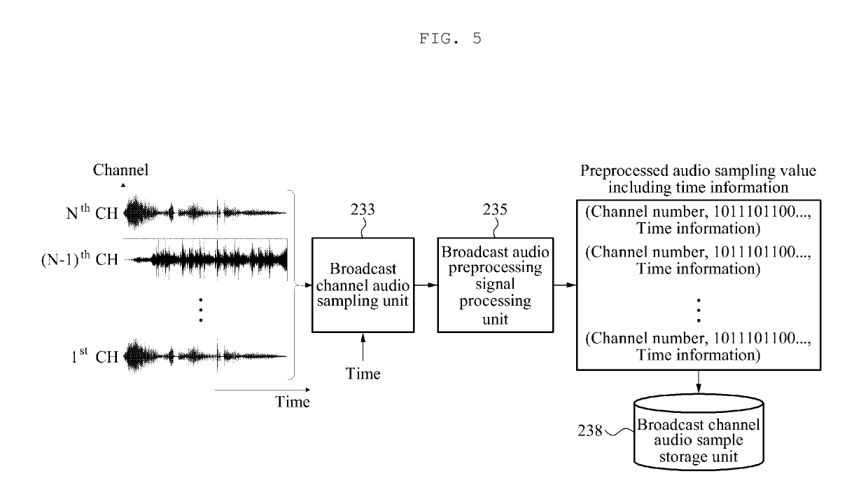

FIG. 5 is a diagram illustrating a sampling operation for obtaining a viewing channel identifier in a broadcast participation device according to an embodiment of the present invention. The broadcast channel audio receiver 231 and the broadcast channel audio sampling unit 233 will be described with reference to FIG. 5.

The broadcast channel audio receiver 231 may receive audio data for N broadcast channels received from the broadcast data transmission server 300 of the broadcasting station. Referring to a waveform of FIG. 5, a continuous audio signal for the N channels may be delivered to the broadcast channel audio sampling unit 233.

As illustrated in FIG. 5, the broadcast channel audio sampling unit 233 may sample continuous audio data of each channel for a predetermined time period.

The broadcast audio preprocessing signal processing unit 235 may receive and store the sampled audio data, perform comparative analysis for the sampled audio data, convert the sampled audio data into a signal form for communication, and encode the sampled audio data.

As illustrated in FIG. 5, in response to the sampled audio data being encoded in the broadcast audio preprocessing signal processing unit 235, an audio sampling value including time information may be obtained. That is, the sampled and preprocessed audio data may include the corresponding broadcast channel number, a sampling audio data value, and time information of reproducing an audio.

A broadcast channel audio sample storage unit 238 may store a broadcast channel audio sample that is sampled and preprocessed by the broadcast channel audio sampling unit 233 and the broadcast audio preprocessing signal processing unit 235.

The viewing channel determining unit 240 may receive viewing channel audio sampling data received from the broadcast participation device 100, and compare the viewing channel audio sampling data to the broadcast channel audio sample stored in the broadcast channel audio sample storage unit 238. The viewing channel determining unit 240 may obtain the viewing channel identifier of the user viewing channel according to a result of the comparison.

The viewing channel identifier may correspond to an identifier capable of identifying at least one channel among a channel number, a channel identification (ID), a channel uniform resource locator (URL), a multicast number, and a port number.

The broadcast receiver 150 may include a broadcast receiving unit 151 and an audio device 152.

The broadcast receiving unit 151 of the broadcast receiver 150 may receive broadcast data for a channel selected by a viewer from the broadcast data transmission server 300 through a broadcast network.

The audio device 152 may output audio data included in the broadcast data that is received through the broadcast receiving unit 151. The audio device 152 may include a device such as a speaker that outputs an audio.

The broadcast participation device 100 may include a microphone module 101, a current viewing channel broadcast audio window sampling unit 103, a broadcast audio preprocessing signal processing unit 105, and a transmitter (not shown).

The microphone module 101 may receive audio data output from the audio device 152 of the broadcast receiver 150. The microphone module 101 may receive an input of audio data output from the audio device 152 such as a speaker.

The current viewing channel broadcast audio window sampling unit 103 may sample audio data of a broadcast channel a viewer is currently viewing.

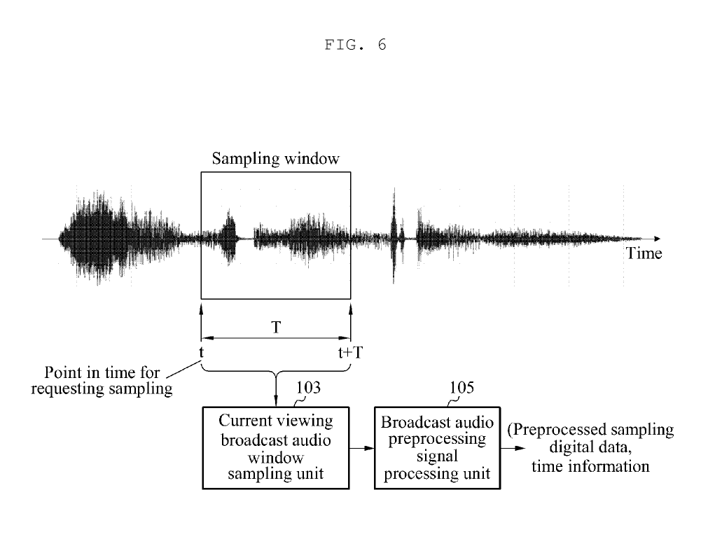

FIG. 6 is a diagram illustrating a sampling operation for obtaining a viewing channel identifier in a channel identification server according to an embodiment of the present invention.

Referring to FIG. 6, the current viewing broadcast audio window sampling unit 103 may set, to a sampling window T, a predetermined time period T from a point in time t for requesting a sampling, and may extract audio data during the sampling window T. The current viewing broadcast audio window sampling unit 103 may generate, from the extracted audio data, a sample bit stream quantized by a sampling algorithm.

The broadcast audio preprocessing signal processing unit 105 may receive and encode the audio data sampled by the current viewing broadcast audio window sampling unit 103.

The transmitter (not shown) may transmit the sampled and encoded audio data to the channel identification server 230 to obtain a viewing channel identifier in the channel identification server 230.

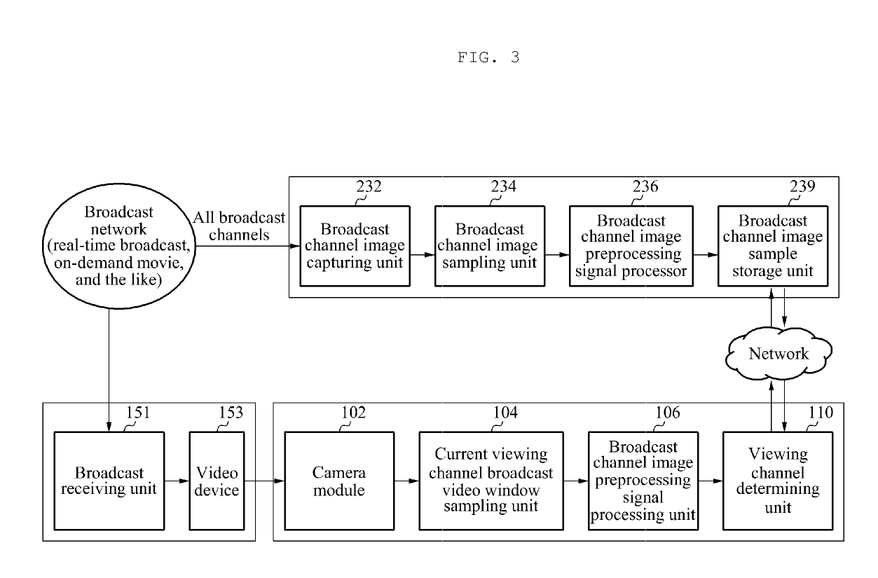

FIG. 3 is a block diagram illustrating a configuration of a system connection for obtaining a viewing channel identifier according to another embodiment of the present invention.

FIG. 3 illustrates a configuration for obtaining, using video data of a viewing channel and video data of all broadcast channels, a viewer channel identifier in the broadcast participation device 100.

Referring to FIG. 3, a system for obtaining a viewing channel identifier according to another embodiment of the present invention may include a channel identification server 230, a broadcast receiver 150, and a broadcast participation device 100.

The channel identification server 230 may include a broadcast channel image capturing unit 232, a broadcast channel image sampling unit 234, broadcast channel image preprocessing signal processor 236 and a broadcast channel image sample storage unit 237.

The broadcast channel image capturing unit 232 may receive video data for all broadcast channels received through a broadcast network, and may deliver the video data to the broadcast channel image sampling unit 234.

The broadcast channel image sampling unit 234 may sample video data for all broadcast channels received through the broadcast channel image capturing unit 232. The broadcast channel image sampling unit 234 may convert, using a sampling algorithm, a continuous video signal for the video data into a digital signal.

A description for operation of the broadcast channel image sampling unit 234 is similar to the sampling operation for an audio of FIG. 5. That is, a video signal that continues during a predetermined time period for N broadcast channels received from the broadcast data transmission server 300 of the broadcasting station may be sampled by the broadcast channel image sampling unit 234.

A broadcast channel image preprocessing signal processor 236 may receive and store the sampled video data, perform comparative analysis for the sampled video data, convert the sampled video data into a signal form for communication, and encode the sampled video data.

The broadcast channel image sample storage unit 239 may store the sampled and encoded video data. Data stored in the broadcast channel image sample storage unit 239 may include the corresponding broadcast channel number, a sampling video data value, and time information for reproducing a sampled video.

According to another embodiment of the present invention, the transmitter (not shown) may transmit the sampled and encoded broadcast channel video data to the broadcast participation device 100 to obtain a viewing channel identifier in the broadcast participation device 100.

The broadcast receiver 150 may include a broadcast receiving unit 151 and a video device 153.

The broadcast receiving unit 151 of the broadcast receiver 150 may receive, from the broadcast data transmission server 300 through a broadcasting network, broadcast data for a channel selected by a viewer.

The video device 153 may output video data included in the broadcast data that is received through the broadcast receiving unit 151. The video device 153 may include a device such as a television or a monitor that may output a video.

The broadcast participation device 100 may include a camera module 102, a current viewing channel broadcast video sampling unit 104, a broadcast channel image preprocessing signal processing unit 106, and a viewing channel determining unit 110.

The camera module 102 may receive image data output from the video device 153 of the broadcast receiver 150. The camera module 102 may include a receiver to receive the image data or a photographing unit to photograph the image.

The current viewing channel broadcast video sampling unit 104 may sample image data for a viewing channel that is selected and viewed by a user.

A description of the image sampling is similar to a configuration and an operation of an audio sampling described with reference to FIG. 6. That is, the current viewing channel broadcast video window sampling unit 104 may set, to a sampling window, a predetermined time period T from a point in time t for requesting a sampling, and may extract video data during the sampling window. The current viewing channel broadcast video sampling unit 104 may generate, from the extracted video data, a sample bit stream quantized by a sampling algorithm.

The broadcast channel image preprocessing signal processing unit 106 may receive and encode the image data sampled by the current viewing channel broadcast video sampling unit 104.

The viewing channel determining unit 110 may receive broadcast channel image sampling data from the participation control server 220, and may compare the broadcast channel image sampling data to the viewing channel broadcast image sampling data. The viewing channel determining unit 110 may obtain the viewing channel identifier according to a result of comparison.

As described in the foregoing, an embodiment of the present invention corresponds to an example of determining, using the viewing channel audio sampling data obtained in the broadcast participation device 100 side, a viewing channel in the participation control server 220, and obtaining an identifier. Another embodiment of the present invention corresponds to an example of determining, using the viewing channel image sampling data obtained in the broadcast participation device 100 and the broadcast image sampling data obtained in the participation control server 220, a viewing channel in the participation control server 220, and obtaining an identifier.

The present invention may have a configuration in which a viewing channel is determined in the participation control server 220, using the viewing channel image sampling data obtained in the broadcast participation device 100, and an identifier is obtained.

The present invention may have a configuration in which a viewing channel is determined in the participation control server 220 using the viewing channel audio sampling data obtained in the broadcast participation device 100 and the broadcast audio sampling data obtained in the participation control server 220.

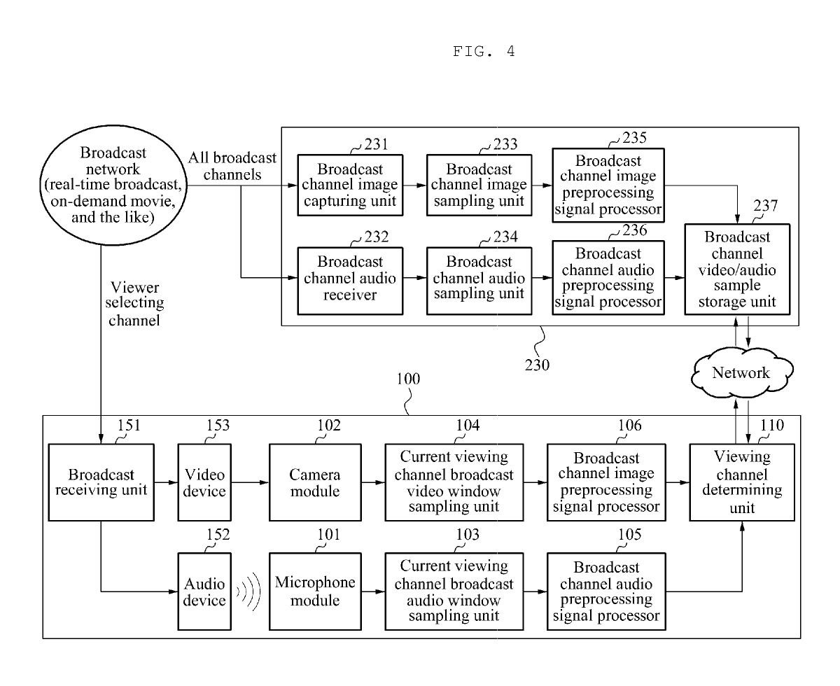

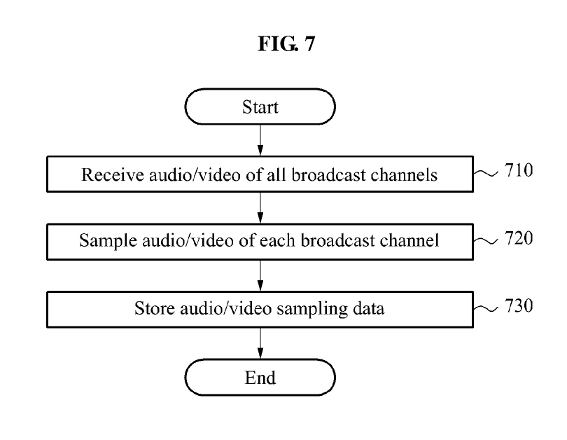

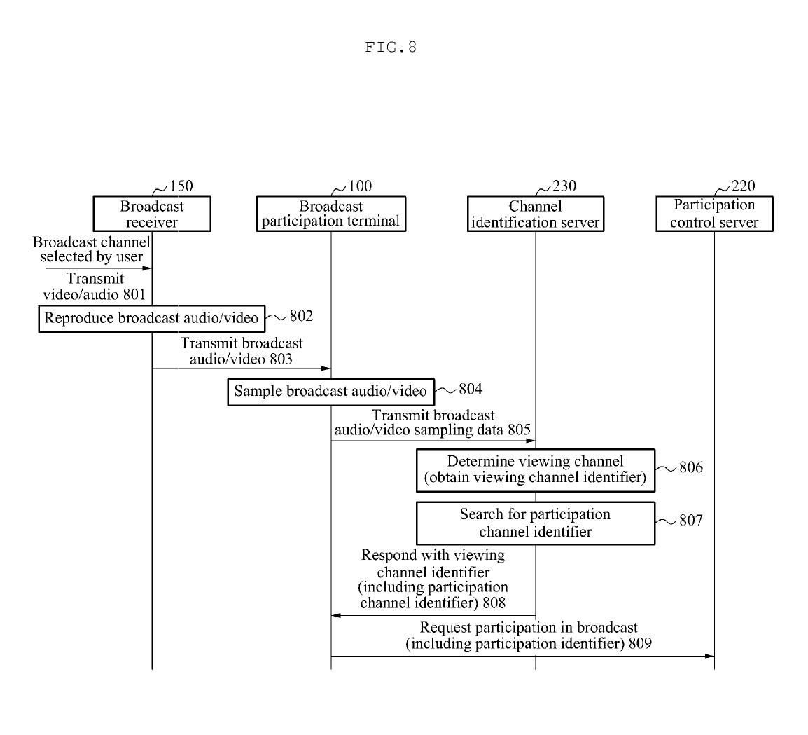

FIG. 4 is a block diagram illustrating a configuration of a system connection for obtaining a viewing channel identifier according to still another embodiment of the present invention. FIG. 7 is a flowchart illustrating an operation of collecting sampling data of a broadcast channel in a channel identification server according to an embodiment of the present invention. FIG. 8 is a flowchart illustrating an operation of a system for obtaining a viewing channel identifier according to an embodiment of the present invention.

Still another embodiment including an embodiment and another embodiment of the present invention will be described with reference to FIGS. 4, 7, and 8.

Still another embodiment of the present invention illustrated in FIG. 4 may have a configuration in which a viewing channel is determined in the participation control server 220 using the viewing channel audio sampling data obtained in the broadcast participation device 100 and the broadcast audio sampling data and the broadcast image sampling data obtained in the participation control server 220, an identifier is obtained.

Referring to FIG. 4, a system for obtaining a viewing channel identifier according to still another embodiment of the present invention may include a channel identification server 230, a broadcast receiver 150, and a broadcast participation device 100.

The channel identification server 230 may include a broadcast channel image capturing unit 231, a broadcast channel audio receiver 232, a broadcast channel image sampling unit 233, a broadcast channel audio sampling unit 234, a broadcast channel image preprocessing signal processor 235, a broadcast channel audio preprocessing signal processor 236, and a broadcast channel video/audio sample storage unit 237.

The broadcast receiver 150 may include a broadcast receiving unit 151, an audio device 152, and a video device 153.

The broadcast participation device 100 may include a microphone module 101, a camera module 102, a current viewing channel broadcast audio window sampling unit 103, a current viewing channel broadcast video window sampling unit 104, a broadcast channel audio preprocessing signal processor 105, a broadcast channel image preprocessing signal processor 106, and a viewing channel determining unit 110.

The viewing channel determining unit 110 may be included in the channel identification server 230 rather than the broadcast participation device 100.

A system and operation for obtaining a viewing channel according to still another embodiment of the present invention will be further described with reference to FIGS. 7 and 8.

In operation 710, the broadcast channel image capturing unit 231 and the broadcast channel audio receiver 232 of the channel identification server 230 may receive audio and video data for each of all N broadcast channels received through a broadcast network, and deliver the audio and video data to the broadcast channel image sampling unit 233 and the broadcast channel audio sampling unit 234.

In operation 720, the broadcast channel image sampling unit 233 and the broadcast channel audio sampling unit 234 may sample an audio and video data according to each broadcast channel.

In operation 730, the sampled audio and video data may be stored in the broadcast channel video/audio sample storage unit 237.

In operation 801, the broadcast receiving unit 151 of the broadcast receiver 150 may receive a broadcast video and audio of a channel selected by a user. In operation 802, the received broadcast video and audio of the channel selected by the user may be reproduced through the audio device 152 and the video device 153, respectively.

In operation 803, the broadcast video and audio reproduced by the audio device 152 and the video device 153, respectively may be transmitted to the microphone module 101 and the camera module 102 of the broadcast participation device 100.

The microphone module 101 and the camera module 102 of the broadcast participation device 100 may receive, from the broadcast receiving unit 100, each of an audio and a video of a viewing channel, and deliver each of the audio and the video to the current viewing channel broadcast audio sampling unit 154 and the current viewing channel broadcast video sampling unit 155.

In operation 804, the current viewing channel broadcast audio sampling unit 103 and the current viewing channel broadcast video window sampling unit 104 may sample audio data and video data, respectively. The sampling may use a scheme described in an embodiment and another embodiment of the present invention. That is, a sampling may be performed by extracting continuous audio and video data during a predetermined time period from a point in time for requesting the sampling.

In operation 805, the sampled viewing channel audio and video sampling data may be transmitted to the viewing channel determining unit 110 of the channel identification server 230 through the transmitter (not shown).

The viewing channel determining unit 110 of the channel identification server 230 may compare the viewing channel audio and the video sampling data received from the broadcast participation device 100 to the audio and video sampling data for N broadcast channels stored in operation 730 of FIG. 7. In operation 806, the viewing channel determining unit 110 may determine a viewing channel, and obtain a viewing channel identifier for the viewing channel according to a result of comparison.

In operation 807, the viewing channel determining unit 110 of the channel identification server 230 may search for a participation channel identifier corresponding to the obtained viewing channel identifier.

When the participation channel identifier corresponding to the viewing channel identifier exists, the channel identification server 230 may transmit, to the broadcast participation device 100, the viewing channel identifier and the participation channel identifier in operation 808.

In operation 809, the broadcast participation device 100 may transmit, using the viewing channel identifier and the participation channel identifier received from the channel identification server 230, a signal that requests an interactive broadcast to the participation control server 220.

Accordingly, the participation control server 220 may use a signal that requests an interactive broadcast and a viewing channel identifier received from the broadcast participation device 100 to apply to survey viewer ratings, identify a commercial program, and trace an exposure.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

It is to be understood that both the foregoing general description and the following detailed description are exemplary and explanatory and are intended to provide further explanation of the invention as claimed.

1. An apparatus for obtaining channel information using broadcast data, the apparatus comprising:
an audio/video receiver to collect broadcast data from a user viewing channel, and extract audio/video data from the collected broadcast data;
a sampling unit to sample the extracted audio/video data;
a preprocessing unit to encode the sampled audio/video data; and
a viewing channel determining unit to compare the encoded audio/video data to audio/video sampling data for N broadcast channels received from a channel identification server, and obtain a viewing channel identifier according to a result of comparison.

2. The apparatus of claim 1, wherein the sampling unit performs sampling by extracting continuous audio/video data for a predetermined time period.

3. The apparatus of claim 1, wherein the audio/video receiver comprises a microphone module for collecting audio data and a camera module for collecting video data, the audio data and the video data being received by a broadcast receiver.

4. The apparatus of claim 1, wherein the viewing channel determining unit determines the viewing channel identifier by extracting sampling data of a broadcast channel including a section that corresponds to sampling data of the viewing channel included in the audio/video sampling data for N broadcast channels received from the channel identification server.

5. The apparatus of claim 1, wherein the viewing channel identifier corresponds to an identifier capable of identifying at least one among a channel number, a channel identification (ID), a channel uniform resource locator (URL), a multicast number, and a port number.

6. The apparatus of claim 1, further comprising:
a participation signal transmitter to request, using the viewing channel identifier in the viewing channel determining unit, the channel identification server to search for a participation channel identifier, and to transmit a broadcast participation request signal to a participation control server using the requested participation channel identifier.

7. An apparatus for obtaining channel information using broadcast data, the apparatus comprising:
a broadcast data receiver to receive, from a broadcasting station, broadcast data for N channels, and to extract audio or video data from the received broadcast data;
a sampling unit to sample the audio or video data extracted by the broadcast data receiver;
a preprocessing unit to encode the sampled audio or video data;
a sampling data storage unit to store the encoded audio or video data; and
a viewing channel determining unit to compare sampling data stored in the sampling data storage unit to audio or video sampling data for a user viewing channel received from a broadcast participation device, and to obtain a viewing channel identifier of the user viewing channel according to a result of comparison.

8. The apparatus of claim 7, wherein the sampling unit performs sampling by extracting continuous audio or video data for a predetermined time period for each of N channels received from the broadcasting station.

9. The apparatus of claim 7, wherein the sampling data storage unit stores time information of the audio or video sampling data.

10. The apparatus of claim 7, wherein the viewing channel identifier corresponds to an identifier capable of identifying at least one among a channel number, a channel identification (ID), a channel uniform resource locator (URL), a multicast number, and a port number.

11. The apparatus of claim 7, further comprising:
a transmitter to search for a participation channel identifier with reference to the viewing channel identifier in the viewing channel determining unit, and to transmit, to the broadcast participation device, the viewing channel identifier including the participation channel identifier searched for.

12. A method of obtaining channel information using broadcast data, the method comprising:
receiving broadcast data of a viewing channel;
extracting audio or video data from the received broadcast data;
sampling the extracted audio or video data;
comparing the sampled audio or video data to audio or video sampling data for N broadcast channels received from a channel identification server; and
obtaining a viewing channel identifier of the viewing channel according to a result of comparison.

13. The method of claim 12, wherein the sampling comprises:
extracting data during a sampling window of a predetermined section for audio or video data of a viewing channel; and
generating a quantized sample bit stream for the extracted data.

14. The method of claim 12, further comprising:
searching for a participation channel identifier with reference to the obtained viewing channel identifier; and
requesting an interactive broadcast by transmitting the participation channel identifier searched for to a participation control server.

15. A method of obtaining channel information using broadcast data, the method comprising:
receiving, from a broadcasting station, broadcast data for each broadcast channel;
extracting audio or video data from the received broadcast data;
sampling the extracted audio or video data;
comparing the sampled audio or video data to audio or video sampling data for a user viewing channel received from a broadcast participation device; and
obtaining a viewing channel identifier for the viewing channel according to a result of comparison.

16. The method of claim 15, wherein the sampling comprises:
setting a sampling section for a continuous audio or video signal for a predetermined time period; and
generating a quantized sample bit stream for audio or video data of the sampling section.

17. The method of claim 15, further comprising:
searching for a participation channel identifier with reference to the obtained viewing channel identifier; and
transmitting, to the broadcast participation device, the participation channel identifier searched for and the viewing channel identifier.

18. An apparatus for obtaining channel information using broadcast data, the apparatus comprising:
an audio/video receiver to collect broadcast data from a user viewing channel, and to extract audio or video data from the collected broadcast data;
a sampling unit to sample the extracted audio or video data;
a preprocessing unit to encode the sampled audio or video data; and
a transmitter to transmit, to a channel identification server, the encoded audio or video data.

19. The apparatus of claim 18, wherein the viewing channel identifier and a broadcast participation identifier are received from the channel identification server, and the received viewing channel and broadcast participation identifiers are transmitted to a broadcast participation server to request an interactive broadcast.

20. The apparatus of claim 18, wherein the sampling unit performs sampling by extracting continuous audio or video data for a predetermined time period.
